(19) United States
(12) Patent Application Publication
(10) Pub. No.: US 2005/0054758 A1
(43) Pub. Date: Mar. 10, 2005

(54) Adhesive substance, adhesive product, and connected structure

(76) Inventors: Munehiro Hatai, Mishima-gun (JP); Masateru Fukuoka, Mishima-gun (JP); Satoshi Hayashi, Mishima-gun (JP); Shigeru Danjo, Mishima-gun (JP); Yasuhiko Oyama, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/497,106

(22) PCT Filed: Jun. 3, 2002
(86) PCT No.: PCT/JP02/05408

(30) Foreign Application Priority Data
Apr. 12, 2001 (JP) 2001-370758

(51) Int. Cl. C08K 5/23

(52) U.S. Cl. 524/190

(57) ABSTRACT

It is an object of the present invention to provide an adhesive substance capable of being easily peeled off without damaging an adherend by means of irradiation with light, an adhesive product, and a connected structure. The present invention relates to an adhesive substance containing an azo compound generating gas by means of irradiation with light, at least part of gas generated from said azo compound being discharged to the outside of said adhesive substance.

### TECHNICAL FIELD

The present invention relates to an adhesive substance capable of being easily peeled off without damaging an adherend by means of irradiation with light, an adhesive product, and a connected structure.

### BACKGROUND ART

Nowadays, adhesive substances have been widely used for a binder agent such as an adhesive, a sealing agent, a paint and a coating material, a pressure-sensitive adhesive such as a pressure-sensitive adhesive tape and a self-supporting tape, and the like.

The performances required for these adhesive substances vary with uses thereof, and some uses require that the adhesive substances exhibit adhesive property only while required, but can be easily peeled off thereafter.

For example, in the manufacturing process of IC chips, it has been proposed that a thick-film wafer is reinforced by adhering to a support plate to thereby advance the work efficiently, in the case where the thick-film wafer cut out of high-purity silicon single crystal is polished to a predetermined thickness into a thin-film wafer. Then, it is required that the adhesive substances between the thick-film wafer and the support plate stick them together firmly during the polishing process and, meanwhile, allows the obtained thin-film wafer to be peeled off the support plate without damaging after the polishing process.

A method for peeling off the adhesive substances is, for example, thought to peel off by applying physical force; however, this method has the possibility of bringing a serious damage in the case where an adherend is weak.

In addition, a method is thought such as to peel off the adhesive substances by using a solvent for dissolving them; however, this method can not be employed in the case where an adherend is affected by the solvent.

Thus, there has been a problem in that a firmer adhesive strength of the adhesive substances once used for adhering makes it more difficult to peel off without damaging an adherend.

By contrast, a pressure-sensitive adhesive containing an azide compound is disclosed in Japanese Kokai Publication 2001-200234. An azide compound decomposes to discharge nitrogen gas by being irradiated with ultraviolet rays. Accordingly, when an adhesive surface stuck by using a pressure-sensitive adhesive containing an azide compound is irradiated with ultraviolet rays, nitrogen gas discharged by the decomposition of the azide compound peels a part of the adhesive surface of the pressure-sensitive adhesive off an adherend so as to decrease adhesive strength, whereby the adherend can be easily peeled off.

However, the azide compound easily decomposes to discharge nitrogen gas also by giving impact; therefore, it has a problem in that the handling thereof is difficult. In addition, the azide compound once starts to decompose and causes a chain reaction to explosively discharge nitrogen gas beyond control, whereby it has a problem in that an adherend is occasionally damaged by the nitrogen gas explosively discharged.

### SUMMARY OF THE INVENTION

In view of the above-mentioned circumstances, it is an object of the present invention to provide an adhesive substance capable of being easily peeled off without damaging an adherend by means of irradiation with light, an adhesive product, and a connected structure.

The present invention is directed to an adhesive substance containing an azo compound which generates gas by means of irradiation with light, wherein at least part of gas generated from said azo compound is discharged to the outside of said adhesive substance.

Preferably, the azo compound does not exist as particles in the adhesive substance and, more preferably, it is an azoamide compound represented by the formula (1): 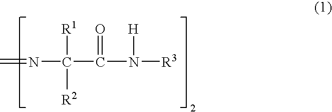
in the formula (1), R¹ and R² each represents the same or different lower alkyl group, and R³ represents a saturated alkyl group with a carbon number of 2 or more.

Gas discharged from the azo compound preferably peels at least part of an adhesive surface of the adhesive substance off an adherend so as to decrease adhesive strength.

The adhesive substance of the present invention preferably contains a photosensitizer and, also, preferably contains a component crosslinkable by giving stimulation via light or stimulation other than light.

The adhesive substance of the present invention preferably has tan δ decreased in a rubbery region by giving stimulation via light or stimulation other than light, and preferably exhibits pressure-sensitive adhesive property at least at ordinary temperature before giving stimulation via light or stimulation other than light causing the decrease of tan δ. Further, the adhesive substance of the present invention is preferably an adhesive.

The present invention is also directed to an adhesive product comprising the adhesive substance of the present invention, and a connected structure obtained by bonding at least two adherends via the adhesive substance of the present invention.

### DETAILED DISCLOSURE OF THE INVENTION

Hereinafter, the present invention will be described in detail.

An adhesive substance of the present invention contains an azo compound which generates gas by means of irradiation with light.

Incidentally, an adhesive substance in the present description denotes a substance having adhesive property in a state of being applied to an adherend, and is not particularly limited as long as it is a substance exhibiting the property of adhering to at least a surface to adhere to.

In addition, light in the present description includes not only infrared rays, visible rays and ultraviolet rays but also ionizing radiation such as electron rays, X-rays and neutron rays.

The above-mentioned azo compound which generates gas by means of irradiation with light preferably does not exist as particles in the adhesive substance of the present invention. Incidentally, in the present description, the nonexistence of the azo compound as particles in the adhesive substance signifies that the azo compound cannot be confirmed when the cross section of the adhesive substance is observed by an electron microscope. When the azo compound which generates gas by means of irradiation with light exists as particles in the adhesive substance of the present invention, ultraviolet rays are scattered at an interface of the particles in irradiating with ultraviolet rays so as to decrease gas-generating efficiency and surface smoothness is deteriorated in making the adhesive substance of the present invention into a state of a coating film.

In order that the above-mentioned azo compound does not exist as particles, an azo compound to be dissolved in the adhesive substance of the present invention is typically selected; meanwhile, in the case of selecting an azo compound not to be dissolved in the adhesive substance of the present invention, the azo compound is minutely dispersed into the adhesive substance of the present invention, for example, by using a disperser and a dispersant together therewith.

In addition, the gas-generating agent is preferably minute particles. Further, these minute particles are preferably made into finer minute particles as required, for example, by using a disperser, a kneading device and the like. That is to say, when the adhesive substance of the present invention is observed by an electron microscope, the gas-generating agent is more preferably dispersed to a state of being incapable of confirmation.

Examples of the above-mentioned azo compound which generates gas by means of irradiation with light may include 2,2′-azobis(N-cyclohexyl-2-methyl propionamide), 2,2′-azobis[N-(2-methyl propyl)-2-methyl propionamide], 2,2′-azobis(N-butyl-2-methyl propionamide), 2,2′-azobis[N-(2-methyl ethyl)-2-methyl propionamide], 2,2′-azobis(N-hexyl-2-methyl propionamide), 2,2′-azobis(N-propyl-2-methyl propionamide), 2,2′-azobis(N-ethyl-2-methyl propionamide), 2,2′-azobis{2-methyl-N-[1,1-bis(hydroxymethyl)-2-hydroxyethyl]propionamide}, 2,2′-azobis{2-methyl-N-[2-(1-hydroxybutyl)]propionamide}, 2,2′-azobis[2-methyl-N-(2-hydroxyethyl)propionamide], 2,2′-azobis[N-(2-propenyl)-2-methyl propionamide], 2,2′-azobis[2-(5-methyl-2-imidazoline-2-yl)propane]dihydrochloride, 2,2′-azobis[2-(2-imidazoline-2-yl)propane]dihydrochloride, 2,2′-azobis[2-(2-imidazoline-2-yl)propane]disulfate dihydrolate, 2,2′-azobis[2-(3,4,5,6-tetrahydropyrimidine-2-yl)propane]dihydrochloride, 2,2′-azobis{2-[1-(2-hydroxyethyl)-2-imidazoline-2-yl]propane}dihydrochloride, 2,2′-azobis[2-(2-imidazoline-2-yl)propane], 2,2′-azobis(2-methyl propionamidine)hydrochloride, 2,2′-azobis(2-aminopropane)dihydrochloride, 2,2′-azobis[N-(2-carboxyacyl)-2-methyl-propionamidine], 2,2′-azobis{2-[N-(2-carboxyethyl)amidine]propane}, 2,2′-azobis(2-methyl propionamide oxime), dimethyl2,2′-azobis(2-methyl propionate), dimethyl2,2′-azobisisobutyrate, 4,4′-azobis(4-cyanocarbonic acid), 4,4′-azobis(4-cyanopentanoic acid), 2,2′-azobis(2,4,4-trimethylpentane), and the like.

In particular, an azoamide compound represented by the following formula (1) is preferable, such as 2,2′-azobis(N-cyclohexyl-2-methyl propionamide), 2,2′-azobis[N-(2-methyl propyl)-2-methyl propionamide], 2,2′-azobis(N-butyl-2-methyl propionamide), 2,2′-azobis[N-(2-methyl ethyl)-2-methyl propionamide], 2,2′-azobis(N-hexyl-2-methyl propionamide), 2,2′-azobis(N-propyl-2-methyl propionamide) and 2,2′-azobis(N-ethyl-2-methyl propionamide).

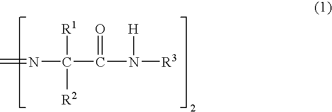

In the formula (1), R¹ and R² each represents lower alkyl group, and R³ represents a saturated alkyl group with a carbon number of 2 or more. Herein, R¹ and R² may be the same as or different from each other.

The azoamide compound represented by the formula (1) is excellent in heat resistance, and can be used at high temperature and stored in a stable state. When the heat resistance is low, the adhesive substance of the present invention may cause foaming upon forming and drying using a cast, or may cause a decomposition reaction to occur with time, resulting in bleeding of a decomposed residue or may generate gas with time to occur floating at the interface between the adhesive substance and an adherend.

The azoamide compound represented by the formula (1) is also excellent in the solubility in a photocuring adhesive resin, which is reduced in tan δ by giving stimulation via light, as described later, containing a polymerizable polymer of alkyl acrylic acid esters, and can be one not existing as particles in the adhesive substance.

At least part of gas generated from the above-mentioned azo compound is discharged to the outside of the adhesive substance. Thus, when an adhesive surface stuck by using the adhesive substance of the present invention is irradiated with light, gas generated from the azo compound peels at least part of the adhesive surface of the adhesive substance off an adherend so as to decrease adhesive strength, whereby the adherend can be easily peeled off.

The above-mentioned azo compound, unlike the azide compound, does not generate gas by impact; therefore, the handling thereof is extremely easy. In addition, the above-mentioned azo compound does not cause a chain reaction to explosively generate gas and thereby does not damage an adherend; therefore, it is preferably used in the case where an adhesive substance is peeled off a particularly soft adherend. Further, the interruption of irradiation of light discontinues the generation of gas, whereby it is possible to control adhesive property for uses.

Preferably, the adhesive substance of the present invention further contains a photosensitizer. The above-mentioned photosensitizer is not particularly limited and, for example, a thioxanthone sensitizer is preferable.

The above-mentioned photosensitizer has an effect of amplifying stimulation to the above-mentioned azo compound via light, so that by containing the photosensitizer, the adhesive substance of the present invention can cause the above-mentioned azo compound to discharge gas by means of irradiation with light of wavelengths in the region other than a photosensitive region of the azo compound. Further, the range of choices of an adherend is extended since by adjusting an amount of the above-mentioned azo compound and the above-mentioned photosensitizer to be contained in the adhesive substance, it is possible to freely control the quantity of light required for generating gas and the time required for generating gas and to provide properties matching with the uses. In addition, the thioxanthone sensitizer can be also used as a photoinitiator.

As described above, since the adhesive substance of the present invention is deteriorated in an adhesion strength by gas generated from the azo compound by means of irradiation with light, it can be peeled off without damaging the adherend by heating or the like.

In this case, most of the gas generated from the azo compound is preferably discharged to the outside of the adhesive substance. However, even in this case, part of the generated gas may present as bubbles in the adhesive substance if the adhesive substance is foamed and the cohesion isn't significantly deteriorated.

Preferably, the adhesive substance of the present invention decreases tan δ by giving stimulation in a rubbery range.

Herein, stimulation causing the decrease of tan δ may be stimulation via light or stimulation other than light. In addition, the above-mentioned tan δ is calculated on the basis of storage elastic modulus and loss elastic modulus in measuring dynamic viscoelasticity using a viscoelasticity measuring device, and the decrease of tan δ signifies that the adhesive substance becomes resistant to a plastic deformation. The decrease of tan δ causes an adhesion strength of the adhesive substance itself to decrease. In addition, when gas is generated from a gas-generating agent in the adhesive substance which has become hard, most of the generated gas is discharged to the outside. Therefore, the discharged gas can reduce an adhesion strength by peeling at least part of the adhesive surface of the adhesive substance off an adherend.

Examples of the above-mentioned substance such that tan δ is decreased by giving the stimulation may include a substance which contains a crosslinkable component for crosslinking by giving stimulation via humidity, heat, chemical reaction, light and ultrasonic wave, and thereby is cured or crosslinked by giving stimulation via humidity, heat, chemical reaction, light and ultrasonic wave so that tan δ is decreased; a substance such that tan δ is decreased by phase change from liquid matter to solid matter with the volatilization of a solvent; a substance such that tan δ is decreased by passing electric current; and the like.

Examples of the above-mentioned substance such that tan δ is decreased by giving stimulation via humidity may include humidity-curing type adhesive resin such as a humidity-curing type adhesive, a humidity-curing type pressure-sensitive adhesive and a humidity-curing type sealing agent.

Examples of the above-mentioned adhesive substance such that tan δ is decreased by giving stimulation via said chemical reaction may include two-component-curing type adhesive resin such as a two-component curing type adhesive, a two-component curing type pressure-sensitive adhesive and a two-component curing type sealing agent, and anaerobic-curing type adhesive resin such as an anaerobic-curing type adhesive, an anaerobic-curing type pressure-sensitive adhesive and an anaerobic-curing type sealing agent.

Examples of the above-mentioned adhesive substance such that tan δ is decreased by giving stimulation via light may include photo-curing type adhesive resin such as a photo-curing type adhesive, a photo-curing type pressure-sensitive adhesive and a photo-curing type sealing agent.

Examples of the above-mentioned photo-curing type adhesive resin may include a resin mainly including an acrylic acid alkyl ester and/or methacrylic acid alkyl ester polymerizable polymer having a radical polymerizable unsaturated bond in a molecule, and a radical polymerizable polyfunctional oligomer or monomer, and a photo-polymerization initiator as required.

The above-mentioned polymerizable polymer is obtained, for example, by previously synthesizing a (meth)acrylic polymer having a functional group in a molecule (hereinafter, referred to as a functional group-containing (meth)acrylic polymer) so as to be reacted with a compound having a functional group for reacting with the above-mentioned functional group and a radical polymerizable unsaturated bond in a molecule (hereinafter, referred to as a functional group-containing unsaturated compound).

Incidentally, in this description, a (meth)acrylic polymer refers to an acrylic polymer and a methacrylic polymer.

The above-mentioned functional group-containing (meth)acrylic polymer, similar to the case of a general (meth)acrylic polymer as a polymer having adherence at ordinary temperature, is obtained by conventionally copolymerizing an acrylic acid alkyl ester and/or methacrylic acid alkyl ester as a main monomer, in which a carbon number of an alkyl group is typically in a range of 2 to 18, and a functional group-containing monomer and additionally, as required, another monomer for modifying copolymerizable therewith. The weight-average molecular weight of the above-mentioned functional group-containing (meth)acrylic polymer is typically 200,000 to 2,000,000.

Examples of the above-mentioned functional group-containing monomer may include a carboxyl group-containing monomer such as acrylic acid and methacrylic acid; a hydroxyl group-containing monomer such as hydroxyethyl acrylate and hydroxyethyl methacrylate; an epoxy group-containing monomer such as glycidyl acrylate and glycidyl methacrylate; an isocyanate group-containing monomer such as isocyanateethyl acrylate and isocyanateethyl methacrylate; an amino group-containing monomer such as aminoethyl acrylate and aminoethyl methacrylate; and the like.

Examples of the above-mentioned another copolymerizable monomer for modifying may include various monomers used for a general (meth)acrylic polymer, such as vinyl acetate, acrylonitrile and styrene.

As the above-mentioned functional group-containing unsaturated compound usable for being reacted with the functional group-containing (meth)acrylic polymer, a compound similar to the above-mentioned functional group-containing monomer in accordance with a functional group of the above-mentioned functional group-containing (meth)acrylic polymer can be used. For example, in the case where a functional group of the above-mentioned functional group-containing (meth)acrylic polymer is a carboxyl group, an epoxy group-containing monomer and an isocyanate group-containing monomer are used; in the case where the functional group is a hydroxyl group, an isocyanate group-containing monomer is used; in the case where the functional group is an epoxy group, a carboxyl group-containing monomer and an amide group-containing monomer such as acrylamide are used; and in the case where the functional group is an amino group, an epoxy group-containing monomer is used.

The above-mentioned polyfunctional oligomer or monomer is preferably an oligomer or monomer having a molecular weight of 10,000 or less, and more preferably having a molecular weight of 5,000 or less and a radical polymerizable unsaturated bond number of 2 to 20 in a molecule so that the three-dimensional net working of a pressure-sensitive adhesive layer is efficiently performed by the irradiation of light. Examples of the more preferable polyfunctional oligomer or monomer may include trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxypenta(meth)acrylate, dipentaerythritol hexa(meth)acrylate, and the like. Additionally, examples thereof may include 1,4-butylene glycol di(meth)acrylate, 1,6-hexanediol di(meth)acrylate, polyethylene glycol di(meth)acrylate, commercially available oligoester (meth)acrylate, and the like. These polyfunctional oligomers or monomers may be used singly or together in two kinds or more.

Examples of the above-mentioned photopolymerization initiator may include an initiator activated by being irradiated with light having a wavelength of 250 to 800 nm, and examples of such a photopolymerization initiator may include an acetophenone derivative compound such as methoxyacetophenone; a benzoin ether compound such as benzoin propyl ether and benzoin isobutyl ether; a ketal derivative compound such as benzyl dimethylketal and acetophenone diethylketal; a phosphine oxide derivative compound; a photo-radical polymerization initiator such as a bis(η5-cyclopentadienyl)titanocene derivative compound, benzophenone, Michler's ketone, chlorothioxanthone, dodecylthioxanthone, dimethylthioxanthone, diethylthioxanthone, α-hydroxycyclohexyl phenyl ketone and 2-hydroxymethylphenylpropane. These photopolymerization initiators may be used singly or together in two kinds or more.

When the above-mentioned photo-curable adhesive resin is subjected to stimulation via light, the whole adhesive resin is uniformly and immediately polymerized and crosslinked to be combined into one; therefore, the tan δ is significantly decreased via polymerization curing and an adhesion strength is decreases by a large amount.

Examples of the above-mentioned substance such that tan δ is decreased by giving stimulation via heat may include thermosetting type adhesive resin such as a thermosetting type adhesive, a thermosetting type pressure-sensitive adhesive and a thermosetting type sealing agent.

Examples of the above-mentioned thermosetting type adhesive resin may include resin containing the above-mentioned polymerizable polymer, and the above-mentioned polyfunctional oligomer or monomer as a main component, and including a thermal polymerization initiator, and the like.

Examples of the above-mentioned thermal polymerization initiator may include an initiator which decomposes by heat to generate active radical for initiating polymerization and cure, and specific examples thereof may include dicumyl peroxide, di-tert-butyl peroxide, tert-butyl peroxybenzoale, tert-butyl hydroperoxide, benzoyl peroxide, cumene hydroperoxide, diisopropyl benzene hydroperoxide, para-menthane hydroperoxide, di-tert-butyl peroxide, and the like. In particular, cumene hydroperoxide, para-menthane hydroperoxide, di-tert-butyl peroxide and the like are preferable in view of a high thermal decomposition temperature. A commercially available thermal polymerization initiator among these is not particularly limited, as which Perbutyl D, Perbutyl H, Perbutyl P, Permenta H (all of which are made by NOF CORPORATION) and the like are preferable. In addition, if the decomposition temperature of the thermal polymerization initiator is higher than the thermal decomposition temperature of an azo compound, it becomes difficult to control the amount of gas to be generated since the gas is generated from the azo compound without irradiation with light. Therefore, the decomposition temperature of the thermal polymerization initiator is preferably lower than the decomposition temperature of the azo compound. These thermal polymerization initiators may be used singly or together in two kinds or more.

Examples of the above-mentioned adhesive substance such that tan δ is decreased by giving stimulation via ultrasonic waves may include thermosetting type adhesive resin such as a thermosetting type adhesive, a thermosetting type pressure-sensitive adhesive and a thermosetting type sealing agent.

Examples of the above-mentioned substance such that tan δ is decreased by phase change from liquid matter to solid matter with the volatilization of a solvent may include adhesive resin for curing by the volatilization of a solvent, such as a solvent type adhesive, a solvent type pressure-sensitive adhesive and a solvent type sealing agent.

Examples of the above-mentioned adhesive substance such that tan δ is decreased by passing electric current may include an adhesive substance having electrical conductivity and containing electrorheological fluid, and the like. The passage of electric current through such an electrically-conductive adhesive substance aligns electrorheological-fluid component to decrease tan δ of the adhesive substance.

The adhesive substance of the present invention may be a pressure-sensitive adhesive substance which exhibits pressure-sensitive adhesive properties at least at ordinary temperature before stimulation via light or stimulation other than light causing the tan δ to decrease as described above, or may be an adhesive which does not exhibit pressure-sensitive adhesive properties at ordinary temperature. A substance which exhibits pressure-sensitive adhesive properties at ordinary temperature is preferred because it can be immediately bonded to the surface desired to be bonded.

The adhesive substance of the present invention preferably has thermoplasticity. When the adhesive substance has thermoplasticity, it is possible to make the adhesive substance adhere to an adherend in a state of being softened with heat, so that the adhesive substance absolutely contacts with irregularities on the surface of the adherend and a powerful adhesive strength can be attained.

Examples of a method for producing the adhesive substance of the present invention may include a method for kneading resin components with the above-mentioned azo compound. However, the azo compound may decompose with heat produced in kneading resin components with the azo compound and it may be difficult to produce the adhesive substance containing plenty of the azo compounds.

In such a case, it is preferred to employ a method for activating the above-mentioned photopolymerization initiator by irradiating the raw materials of the adhesive substance containing an azo compound, polymerizable raw materials and a photopolymerization initiator with ultraviolet light or visible light, having a longer wavelength than the photo sensitive wavelength of the azo compound, and polymerizirig the above-mentioned polymerizable raw materials to produce an adhesive substance. If this method is employed, it is not necessary to knead resin components with the azo compound and there is no possibility that the azo compound may start to decompose with heat. In addition, since production of the adhesive substance can be completed at one reaction and it is unnecessary to use a solvent, the adhesive substance containing plenty of the azo compound can be safely and readily produced.

In the above-mentioned method for producing the adhesive substance, a substance based on an acrylic monomer or an acrylic oligomer, for example, is used as a polymerizable raw material and, further, a photopolymerization initiator activated by being irradiated with ultraviolet light or visible light having a longer wavelength than the photo sensitive wavelength of an azo compound is used. Examples of the photopolymerization initiator used herein may include the photo-radical polymerization initiator described above. These photopolymerization initiators may be used alone or in combination of two or more kinds.

The adhesive substance of the present invention can be used in various adhesive products.

Examples of the above-mentioned adhesive product may include an adhesive, a pressure-sensitive adhesive, a paint, a coating material, a sealing agent and the like, which use the adhesive substance of the present invention as a binder resin, or a pressure-sensitive adhesive single coated tape, a pressure-sensitive adhesive double coated tape, a nonsupport tape (a self-supporting tape) and the like, which use the adhesive substance of the present invention as a pressure-sensitive adhesive.

Examples of a pressure-sensitive adhesive tape in which the adhesive substance of the present invention is used as a pressure-sensitive adhesive may include a packaging tape, a decorative tape, a surface protection tape, a masking tape, a dicing tape, a back grind tape and the like.

The present invention encompasses an adhesive product, which is obtainable by using the adhesive substance of the present invention.

The present invention also encompasses a connected structure, which is obtainable by bonding at least two adherends via the adhesive substance of the present invention.

### BEST MODE FOR CARRYING OUT THE INVENTION

The present invention will be further described hereinafter referring to examples; however, the present invention is not limited thereto.

### EXAMPLE 1

### <Preparation of Adhesive Substance>

The following compounds were dissolved in ethyl acetate so as to be irradiated with ultraviolet rays for polymerization and obtain an acrylic copolymer having a weight-average molecular weight of 700,000.

3.5 parts by weight of 2-isocyanatoethyl methacrylate was added to 100 parts by weight of resin solids content of the ethyl acetate solution containing the obtained acrylic copolymer so as to be reacted, and further 20 parts by weight of pentaerythritol triacrylate, 0.5 part by weight of a photopolymerization initiator (IRGACURE 651, 50%-ethyl acetate solution) and 1.5 parts by weight of polyisocyanate were mixed with 100 parts by weight of resin solids content of the reacted ethyl acetate solution to prepare the ethyl acetate solution of an adhesive substance having tan δ decreased by means of irradiation with light.

| | |
|---|---|
| butyl acrylate | 79 parts by weight |
| ethyl acrylate | 15 parts by weight |
| acrylic acid | 1 part by weight |
| 2-hydroxyethyl acrylate | 5 parts by weight |
| photopolymerization initiator | 0.2 part by weight |
| (IRGACURE 651, 50%-ethyl acetate solution) | |
| lauryl mercaptan | 0.02 part by weight |

100 parts by weight of 2,2′-azobis(N-butyl-2-methylpropionamide) was mixed with 100 parts by weight of resin solids content of the ethyl acetate solution of the adhesive substance to prepare an adhesive substance containing an azido compound which generates gas by stimulation and having tan δ decreased by giving stimulation via light. Then, an adhesive containing this adhesive substance as a binder resin was prepared. The resulting adhesive exhibited pressure-sensitive adhesive properties at ordinary temperature.

The resulting adhesive was applied on a quartz glass plate so as to have a thickness of 25 μm after being dried, dried and then bonded to a polyethylene terephthalate resin plate. Then, it was cured at 40° C. for three days.

The obtained adhesive was irradiated with ultraviolet rays from the side of this quartz glass plate to thereafter observe many parts, in which the adhesive was peeled off the glass, on an adhesive interface via the glass. The polyethylene terephthalate resin plate was capable of being easily peeled off the glass plate.

Further, as a result of measuring the tan δ of the adhesive using a viscoelasticity measuring apparatus, the tan δ was decreased after irradiation with ultraviolet rays.

Industrial Applicability

The present invention can provide an adhesive substance capable of being easily peeled off without damaging an adherend by means of irradiation with light, an adhesive product, and a connected structure.

1. An adhesive substance,
which contains an azo compound generating gas by means of irradiation with light,
at least part of gas generated from said azo compound being discharged to the outside of said adhesive substance.

2. The adhesive substance according to claim 1,
wherein the azo compound does not exist as particles in the adhesive substance.

3. The adhesive substance according to claim 1,
wherein the azo compound is an azoamide compound represented by the formula (1): 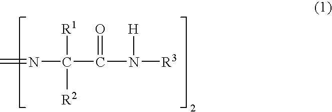
in the formula (1), R¹ and R² each represents the same or different lower alkyl group, and R³ represents a saturated alkyl group with a carbon number of 2 or more.

4. The adhesive substance according to claim 1,
wherein gas generated from the azo compound peels at least part of an adhesive surface of the adhesive substance off an adherend so as to decrease adhesive strength.

5. The adhesive substance according to claim 1,
which contains a photosensitizer.

6. The adhesive substance according to claim 1,
wherein tan δ is decreased in a rubbery region by giving stimulation via light or stimulation other than light.

7. The adhesive substance according to claim 1,
which contains a component crosslinkable by giving stimulation via light or stimulation other than light.

8. The adhesive substance according to claim 1,
which exhibits a pressure-sensitive adhesive property at least at ordinary temperature before giving stimulation via light or stimulation other than light causing the decrease of tan δ.

9. The adhesive substance according to claim 1,
which is an adhesive.

10. An adhesive product,
which is obtainable by using the adhesive substance according to claim 1.

11. A connected structure,
which is obtainable by bonding at least two adherends via the adhesive substance according to claim 1.

12. The adhesive substance according to claim 2,
wherein the azo compound is an azoamide compound represented by the formula (1): 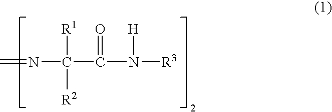
in the formula (1), R¹ and R² each represents the same or different lower alkyl group, and R³ represents a saturated alkyl group with a carbon number of 2 or more.

13. The adhesive substance according to claim 2,
wherein gas generated from the azo compound peels at least part of an adhesive surface of the adhesive substance off an adherend so as to decrease adhesive strength.

14. The adhesive substance according to claim 3,
wherein gas generated from the azo compound peels at least part of an adhesive surface of the adhesive substance off an adherend so as to decrease adhesive strength.

15. The adhesive substance according to claim 3,
which contains a photosensitizer.

16. The adhesive substance according to claim 2,
which contains a photosensitizer.

17. The adhesive substance according to claim 4,
which contains a photosensitizer.

18. The adhesive substance according to claim 3,
wherein tan δ is decreased in a rubbery region by giving stimulation via light or stimulation other than light.

19. The adhesive substance according to claim 3,
which contains a component crosslinkable by giving stimulation via light or stimulation other than light.

20. The adhesive substance according to claim 3,
which exhibits a pressure-sensitive adhesive property at least at ordinary temperature before giving stimulation via light or stimulation other than light causing the decrease of tan δ.
